(19) United States
(12) Patent Application Publication
(10) Pub. No.: US 2021/0110433 A1
(43) Pub. Date: Apr. 15, 2021

(54) VEHICLE CACHING OF LOCAL BUSINESS DATA

(71) Applicant: Ford Global Technologies, LLC, Dearborn, MI (US)

(72) Inventors: Jae Hyung LIM, Canton, MI (US); Jeremy LERNER, Southfield, MI (US); Joseph GIFFORD, Ferndale, MI (US); Daniel SULLIVAN, West Bloomfield, MI (US); Jason Joseph WOO, Northville, MI (US); Taylor HAWLEY, Dearborn, MI (US)

(21) Appl. No.: 16/598,487

(22) Filed: Oct. 10, 2019

(51) Int. Cl. G06Q 30/02; G06K 9/00; H04W 4/029

(52) U.S. Cl. CPC G06Q 30/0266; H04W 4/029; G06K 9/00791; G06Q 30/0252

(57) ABSTRACT

A vehicle includes a camera; a wireless transceiver; and a controller, programmed to responsive to receiving an input requesting to save a location, record a current location of the vehicle, activate the camera to capture an image, and associate the image with the location, responsive to receiving, via the wireless transceiver, a wireless transmission from an advertising business containing a promotion icon, identify the advertising business in the image and modify the image by overlaying the promotion icon on the image to highlight the advertising business, and generate a location report incorporating the location and the image as modified.

### TECHNICAL FIELD

The present disclosure generally relates to an information collecting system for a vehicle. More specifically, the present disclosure relates to vehicle system for collecting business information.

### BACKGROUND

Vehicle users may see local businesses of interest while travelling in a vehicle. Many times, the users may be unable to store the location and business information in time as the vehicle drives by the business quickly. This may be particularly the case for vehicle drivers operating the vehicle. When the users have a chance to research on the businesses seen from the vehicle (e.g. after arriving home), they may already forget the business name and location.

### SUMMARY

In one or more illustrative embodiments of the present disclosure, a vehicle includes a camera; a wireless transceiver; and a controller, programmed to responsive to receiving an input requesting to save a location, record a current location of the vehicle, activate the camera to capture an image, and associate the image with the location, responsive to receiving, via the wireless transceiver, a wireless transmission from an advertising business containing a promotion icon, identify the advertising business in the image and modify the image by overlaying the promotion icon on the image to highlight the advertising business, and generate a location report incorporating the location and the image as modified.

In one or more illustrative embodiments of the present disclosure, a method for a vehicle includes receiving, via a human-machine interface, an input of a user indicative of a request for location saving; loading, from a local storage, a map incorporating a current location of the vehicle; activating a surrounding view camera having multiple lenses to capture multiple pictures; combining, via a processor, the multiple pictures into an image; associating, via the processor, the image with the map; receiving, via a wireless transceiver, a wireless transmission from an advertising business containing a promotion icon; identifying, via the processor, the advertising business in the image; overlaying, via the processor, the promotion icon on the map at a corresponding location of the advertising business to highlight the advertising business on a modified map; overlaying, via the processor, the promotion icon on the image to highlight the advertising business on a modified image; generate, via the processor, a location report incorporating the modified map and the modified image; and responsive to detecting a predefined wireless connection, uploading the location report to a cloud repository.

In one or more illustrative embodiments of the present disclosure, a non-transitory computer-readable medium includes instructions that, when executed by a processor of a vehicle, cause the vehicle to responsive to receiving user input via a human-machine interface, verify a current location of the vehicle, load a map surrounding the current location, capture multiple pictures via multiple camera lenses, combine the multiple pictures into an image, identify a plurality of businesses on the image, separate an image piece containing one or more of the plurality of businesses from the image, and overlay the image piece on the map at a corresponding location of the one or more of the plurality of businesses; responsive to receiving a wireless transmission from an advertising business containing a promotion icon, identify the advertising business in the image, overlay the promotion icon on the image to highlight the advertising business on a modified image, overlay the promotion icon on the map at a corresponding location of the advertising business to highlight the advertising business on a modified map; generate a location report incorporating the modified image and the modified map; and upload the location report to a cloud repository.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example flow diagram of a location saving process of one embodiment of the present disclosure; and

FIG. 3 illustrates an example schematic diagram of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle system for collecting business information. More specifically, the present disclosure proposes a vehicle system for collecting business information using a vehicle camera and/or vehicle-to-everything (V2X) infrastructure.

A vehicle may be provided with cameras to capture images nearby. When a user sees a business of interest (e.g. a new restaurant), an image capturing feature may be triggered via a human-machine interface (HMI) to capture images nearby. Images of the business may be captured by the vehicle cameras. The images as captured may be associated with location and map data of the vehicle to provide more detailed information of the business. In case the vehicle is provided with 360 degree surrounding view camera, a surrounding view picture containing the image of the business may be captured. The vehicle may be further configured to automatically recognize businesses in an image and have the businesses labeled for easier recognition.

Additionally, the vehicle may be further provided with wireless transceivers in support of vehicle-to-vehicle (V2V) or V2X technologies configured to receive advertising or promotions from the nearby businesses. As an example, the wireless transceivers may be configured to support dedicated short-range communication (DSRC) and/or cellular vehicle-to-everything (CV2X) technologies. Metadata from a subscribing business may be received and stored. The subscribing business may be overlaid on the map. At the end of the trip, the stored map, images, and metadata may be presented to the user for review. Alternatively, the vehicle may send the information to an email address or a central repository on a specific website associated with the user.

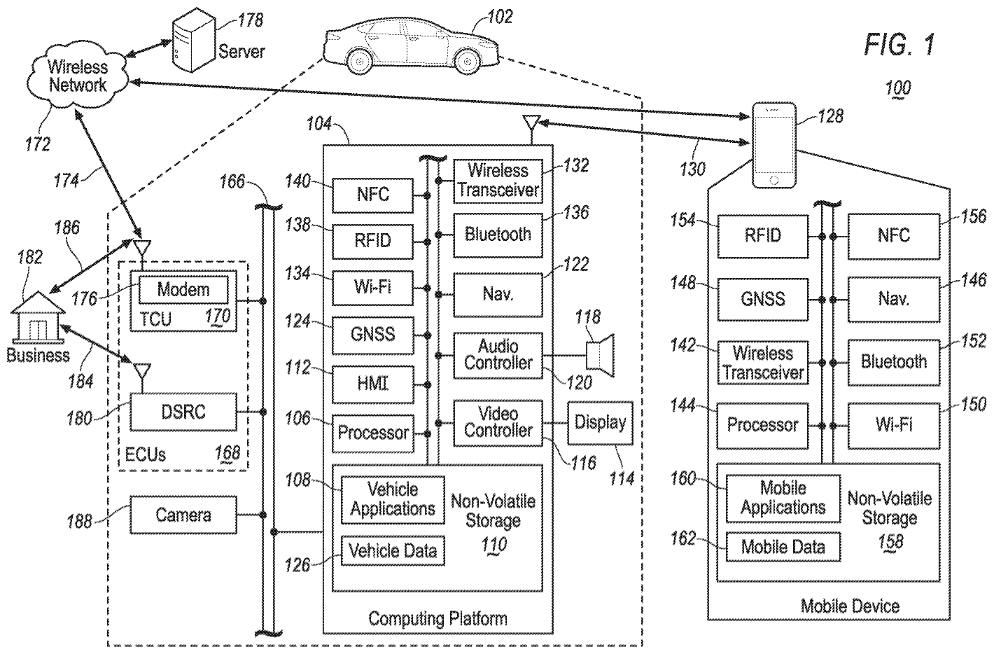

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be battery electric vehicle (BEV), a hybrid electric vehicle (HEV) powered by both an internal combustion engine and one or move electric motors, such as a series hybrid electric vehicle (SHEV), a parallel hybrid electric vehicle (PHEV), or a parallel/series hybrid vehicle (PSHEV), a boat, a plane or other mobile machine for transporting people or goods. As an example, the system 100 may include the SYNC system manufactured by The Ford Motor Company of Dearborn, Mich. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, digital key processing, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants/users to interface with the computing platform 104. For example, the computing platform 104 may receive input from human-machine interface (HMI) controls 112 configured to provide for occupant interaction with the vehicle 102. As an example, the computing platform 104 may interface with one or more buttons (not shown) or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as a part of the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, an ultra-wide band (UWB) transceiver (not shown), and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a navigation controller 146 and a GNSS controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples.

The computing platform 104 may be configured to communicate with various ECUs 168 of the vehicle 102 configured to perform various options. For instance, the computing platform may be configured to communicate with a TCU 170 configured to control telecommunication between vehicle 102 and a wireless network 172 through a wireless connection 174 using a modem 176. The wireless connection 174 may be in the form of various communication network e.g. a cellular network. Through the wireless network 172, the vehicle may access one or more servers 178 to access various content for various purposes. It is noted that the terms wireless network and server are used as general terms in the present disclosure and may include any computing network involving carriers, router, computers, controllers or the like configured to store data and perform data processing functions and facilitate communication between various entities.

The ECUs 168 may further include a DSRC controller 180 configured to communicate with various entities via a wireless V2V or V2X connection. For instance, the DSRC controller 180 may be configured to communicate with a business entity 182 via a DSRC connection 184. The business entity 182 may be an entity located within a wireless communication range from the vehicle 102 provided with a wireless transceiver (not shown) and wirelessly send business information to the vehicle 102. Additionally or alternatively, the business entity 182 may communicate with the vehicle via a CV2X connection 186 through the TCU 170. For instance, responsive to detecting the vehicle 102 is within a transmission range of the wireless transceiver and the vehicle 102 opens to receive business information, the business entity 182 may send a promotion (e.g. a coupon) and/or advertisement to the vehicle via the DSRC connection 184 and/or the CV2X connection 186 directly. The computing platform 104 may be further configured to communicate with a camera 188 configured to capture images near the vehicle 102. The camera 188 may be a front facing camera mounted on a windshield configured to capture images in front of the vehicle 102. Additionally or alternatively, the camera 188 may be a 360-degree surrounding view camera having multiple lenses configured to capture multiple images surrounding the vehicle 102. The multiple images may be processed and combined together into one image by controllers such as the computing platform 104.

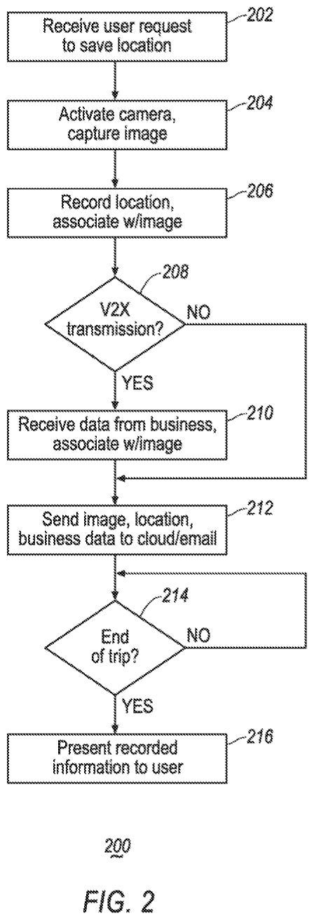

Referring to FIG. 2, an example flow diagram of a location saving process 200 of one embodiment of the present disclosure is illustrated. With continuing reference to FIG. 1, at operation 202, the computing platform 104 of the vehicle 102 receives a user input indicative of a request to save location information. The user input may be received via the HMI controls 112 inform of a voice command or pressing of a button. In response, at operation 204, the computing platform 104 activates the camera 188 and captures an image near the vehicle 102. In case that the camera 188 is provided with 360-degree surrounding view feature consisted of multiple camera lenses, the computing platform 104 be further configured to combine multiple images captured by multiple lenses to generate a surrounding view image. At operation 206, the computing platform 104 records a current location of the vehicle using the location data from the GNSS controller 124 and associates the location with the image captured via the camera 188. For instance, the computing platform 104 may be configured to identify businesses 182 in the image and associate each business 182 with a corresponding location on a map for user reference.

At operation 208, the computing platform 104 verifies if a V2X transmission is received via the TCU 170 and/or the DSRC controller 180. The V2X transmission may be originated from one or more business entities 182 providing business metadata/information to advertise. In addition, the business information for the advertising businesses 182 may further contain promotions such as coupons to encourage the user of the vehicle to stop by. Responsive to receiving the V2X transmission, the process proceeds to operation 210 and the computing platform 104 associates the business data received from the TCU 170 and/or DSRC 180 with the image and location data. For instance, the business data from the advertising business 182 may include a promotion image/icon. The computing platform 104 may identify the advertising business 182 in the image captured by the camera 188 and overlay the promotion image/icon on the captured image. Additionally or alternatively, the computing platform 104 may highlight the advertising business 182 on the captured image for easier recognition. In case the advertising business 182 is not captured by the camera 188, the computing platform 104 may expand the image captured by the camera 188 and add the promotion image/icon into the expanded image.

If no V2X transmission is detected at operation 208, the process proceeds to operation 212 directly. The computing platform 104 stores the captured image, location data, map as well as the business data received from the advertising business 182 (if there is any), and generate a location report to send to a central repository such as the server 178. Additionally or alternatively, the computing platform 104 may be configured to send the location report to a predefined email address associated with the user. The location report may be uploaded via the TCU 170. Alternatively, the computing platform 104 may be configured to use the wireless transceiver 132 to upload the location report using a predefined wireless connection (e.g. a free-of-charge Wi-Fi connection). Additionally or alternatively, the computing platform 104 may be further configured to transmit the location report directly to the mobile device 128 via the wireless connection 130. Additionally, if the computing platform 104 determines the user has finished the trip at operation 214, the location report may be presented to the user via the display 114 and/or the speaker 118.

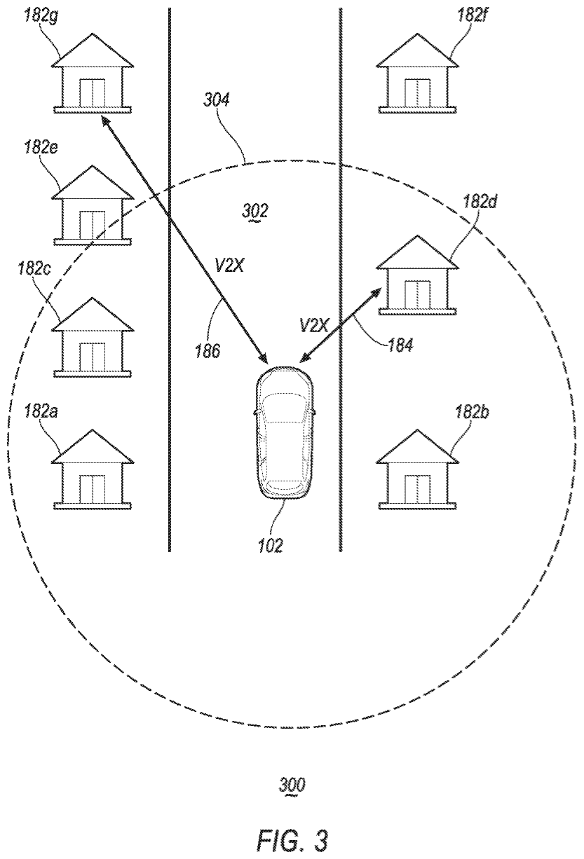

The operations of process 200 may be applied to various situations. Referring to FIG. 3, an example schematic diagram 300 of one embodiment of the present disclosure is illustrated. The vehicle 102 may drive on a road 302 an there may be various businesses alongside the road 302. Responsive to receiving a user input indicative of a request to save location, the computing platform 104 may record a current location data from the GNSS controller 124. The computing platform 104 may further activate one or more cameras 188 to capture images near the vehicle 102. In the present example, the vehicle 102 may be provided with a 360-degree surrounding view camera 182 having a predefined capture range 304. As illustrated with reference to FIG. 3, the capture range 304 covers businesses 182a, 182b, 182c, 182d, 182e and 182f, whereas a business 182g is not within the capture range 304 of the camera 188. Responsive to successfully capturing the image of the businesses, the computing platform 104 may associate the business with the location data from the GNSS controller 124. For instance, the computing platform 104 may identify each business in the image using image recognition technology and divide the image into multiple pieces each containing an image of a business 182. Next the computing platform 104 may put each piece of business image on a location of the map corresponding to the location of the business.

Furthermore, the computing platform 104 may activate the DSRC controller 180 and/or the TCU 170 (as well as other wireless transceivers) to detect for V2X transmission from any advertising businesses nearby. In the present example, the business 182d and 182g may be subscribed to the V2X advertising service and transmit promotion information to the vehicle 102. Responsive to receiving transmissions from the advertising businesses 182d and 182g, the computing platform 104 may process the transmission and attempt to identify those advertising businesses 182d and 182g in the image captured. The transmissions from the businesses 182 may include identification information such as business location, name or the like to facilitate the identification of the advertising business in the image. In the present example, the computing platform 104 may identify the advertising business 182d in the image captured by the camera 188. In response, the computing platform 104 overlay the image/icon received from the advertising business 182d on the image and/or the map. For the advertising business 182g which is not captured by the camera 188, the computing platform 104 may add the advertising image/icon on the image to promote the advertising business 182g. Additionally or alternatively, the computing platform 104 may add the image/icon of the advertising business 182 on the corresponding location of the map for user reference. The computing platform 104 may be further configured to generate a location report for the user to review. The location report may include the image captured by the camera 188 and processed by the computing platform incorporating the advertising businesses 182d and 182g. Alternatively, the computing platform 104 may be configured to only record businesses 182 that is visible to the vehicle user or could have been seen by the user. Those businesses which are not visible by the user or not capture by the vehicle (e.g. business 182g) at the time the button is pressed indicating to save the location may be ignored. This is because the V2X transmission range may cover area beyond the desired location of the user, e.g. from an adjacent street, not seen by the user. Recording V2X transmissions from unintended businesses may be undesired and distractive to the user. The location report may further include the map having images of each business 182 on the corresponding location to present to the user. Responsive successfully generating the location report, the computing platform 104 may upload the location report to a server 178 for the user to review. For instance, the server 178 may include a databased associated with an account of the user. Additionally or alternatively, the computing platform 104 may send the location report to a predefined email address of the user. Additionally or alternatively, the computing platform 104 may be further configured to present the location report to the user directly via the HMI controls 112 in communication with the display 114 and/or the speaker 118.

In an alternative example, the location saving feature may be automatically triggered without user input. For instance, the location saving feature may be configured to be activated while the user operates the vehicle with the DSRC controller 180 and or the TCU 170 activated. Responsive to receiving a V2X transmission from an advertising business 182, the computing platform 104 may launch the location saving feature and generate a location report to promote the advertising business.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle, comprising:
a camera;
a wireless transceiver; and
a controller, programmed to
responsive to receiving an input requesting to save a location, record a current location of the vehicle, activate the camera to capture an image, and associate the image with the location,
responsive to receiving, via the wireless transceiver, a wireless transmission from an advertising business containing a promotion icon, identify a section of the image corresponding to the advertising business and modify the image by overlaying the promotion icon at the section in the image to highlight the advertising business, and
responsive to receiving a second wireless transmission, including a second icon, from a second advertising business located outside a capture range of the camera, expand the image and add the second icon into the image as expanded, and
generate a location report incorporating the location and the image as modified.

2. The vehicle of claim 1, wherein the controller is further programmed to:
responsive to detecting a predefined wireless connection, upload the location report to a server.

3. The vehicle of claim 1, wherein the controller is further programmed to:
send the location report to a predefined email address associated with a user.

4. The vehicle of claim 1, wherein the controller is further programmed to:
transmit the location report to a mobile device associated with a user via a wireless connection.

5. The vehicle of claim 1, wherein the controller is further programmed to:
responsive to detection that the user has finished a trip, output the location report to a user via an in-vehicle display.

6. The vehicle of claim 1, wherein the camera is surrounding view camera having multiple lenses configured to capture multiple pictures, and
the controller is further programmed to:
combine the multiple pictures into the image.

7. The vehicle of claim 1, wherein the controller is further programmed to:
identify a plurality of businesses on the image; and
associate one or more of the plurality of businesses as identified with a map covering the current location of the vehicle.

8. The vehicle of claim 7, wherein the controller is further programmed to:
separate an image piece containing one or more of the plurality of businesses from the image; and
overlay the image piece on the map at a corresponding location of the one or more of the plurality of businesses.

9-10. (canceled)

11. A method for a vehicle, comprising:
receiving, via a human-machine interface, an input of a user indicative of a request for location saving;
loading, from a local storage, a map incorporating a current location of the vehicle;
activating a surrounding view camera having multiple lenses to capture multiple pictures;
combining, via a processor, the multiple pictures into an image;
associating, via the processor, the image with the map;
receiving, via a wireless transceiver, a first wireless transmission from a first advertising business containing a promotion icon;
identifying, via the processor, the advertising business in the image;
overlaying, via the processor, the promotion icon on the map at a corresponding location of the advertising business to highlight the advertising business on a modified map;
overlaying, via the processor, the promotion icon on the image to highlight the advertising business on a modified image;
receiving, via the wireless transceiver, a second wireless transmission including a second icon, from a second advertising business located outside a capture range of the camera;
expand, via the processor, the modified image and add the second icon into an expanded image;
generate, via the processor, a location report incorporating the modified map and the modified image; and
responsive to detecting a predefined wireless connection, uploading the location report to a cloud repository.

12. The method of claim 11, further comprising:
sending the location report to a predefined email address associated with the user.

13. The method of claim 11, further comprising:
transmitting the location report to a mobile device associated with the user via a wireless connection.

14. The method of claim 11, further comprising:
responsive to detect the user has finished a trip, outputting the location report to the user via an in-vehicle display.

15. The method of claim 11, further comprising:
identifying a plurality of businesses on the image;
separating an image piece containing one or more of the plurality of businesses from the image; and
overlaying the image piece on the map at a corresponding location of the one or more of the plurality of businesses.

16. The method of claim 11, further comprising:
responsive to receiving a second wireless transmission, including a second icon, from a second advertising business located outside a capture range of the camera, overlaying the second icon on the map at a corresponding location of the second advertising business.

17. A non-transitory computer-readable medium comprising instructions that, when executed by a processor of a vehicle, cause the vehicle to:
responsive to receiving user input via a human-machine interface,
verify a current location of the vehicle,
load a map surrounding the current location,
capture multiple pictures via multiple camera lenses,
combine the multiple pictures into an image,
identify a plurality of businesses on the image,
separate an image piece containing one or more of the plurality of businesses from the image, and
overlay the image piece on the map at a corresponding location of the one or more of the plurality of businesses;
responsive to receiving a first wireless transmission from a first advertising business containing a first promotion icon,
identify the first advertising business in the image,
overlay the first promotion icon on the image to highlight the advertising business on a modified image,
overlay the first promotion icon on the map at a corresponding location of the first advertising business to highlight the second advertising business on a modified map;
responsive to receiving a second wireless transmission from a second advertising business containing a second promotion icon,
verify the second advertising business outside the image,
expand the modified image and add the second promotion icon to an expanded image;
generate a location report incorporating the modified image and the modified map; and
upload the location report to a cloud repository.

18. The non-transitory computer-readable medium of claim 17, further comprising instructions that, when executed by the processor of the vehicle, cause the vehicle to:
overlay the second icon on the map at a corresponding location of the second advertising business.

19. The non-transitory computer-readable medium of claim 17, further comprising instructions that, when executed by the processor of the vehicle, cause the vehicle to:
transmit the location report to a mobile device associated with the user via a wireless connection.

20. The non-transitory computer-readable medium of claim 17, further comprising instructions that, when executed by the processor of the vehicle, cause the vehicle to:
responsive to detect the vehicle has parked, output the location report to the user via an in-vehicle display.
